(19) United States
(12) Patent Application Publication
(10) Pub. No.: US 2005/0253955 A1
(43) Pub. Date: Nov. 17, 2005

(54) Imaging apparatus, auto focus device, and auto focus method

(76) Inventor: Yutaka Sato, Tokyo (JP)

Correspondence Address: William S. Frommer, Esq.;FROMMER LAWRENCE & HAUG LLP, 745 Fifth Avenue, New York, NY, 10151, US

(21) Appl. No.: 11/127,719

(22) Filed: May 12, 2005

(30) Foreign Application Priority Data
May 14, 2004 (JP) 2004-144553

(51) Int. Cl. H04N 5/232

(52) U.S. Cl. 348/345

(57) ABSTRACT

An imaging apparatus is disclosed, that has an auto focus device that controls the position of a focus lens on the basis of an evaluation value that is a signal obtained by passing predetermined band frequency contained in a video signal, the imaging apparatus comprising means for converting information of an object as light that has been entered through a focus lens into a video signal, obtaining a first video signal, rotating the first video signal by a predetermined angle, and obtaining a second video signal and means for detecting predetermined band frequencies of the first and second video signals and obtaining their evaluation values.

### CROSS REFERENCES TO RELATED APPLICATIONS

The present invention contains subject matter related to Japanese Patent Application No. 2004-144553 filed in the Japanese Patent Office on May 14, 2004, the entire contents of which being incorporated herein by reference.

### BACKGROUND OF THE INVENTION

1. Field of the Invention

The present invention relates to an imaging apparatus, an auto focus device, and an auto focus method that allow an object that does not have gradation in the horizontal direction to be focused.

2. Description of the Related Art

Imaging apparatuses, such as video cameras, digital cameras, and camera modules used for cellular phones, that have been widespread in recent year have an optical system that has a restriction as to the distance for which objects can be imaged with a sufficient resolution. In addition, many imaging apparatuses have a so-called auto focus device that allows an object to be automatically focused.

As a theory of operation of an auto focus device, as described in for example the following Patent Document 1, a technique so-called “climbing-up method”, in which a focal point is obtained by moving a focus lens until a high frequency component of an output of an imaging device becomes the maximum, is known. In the climbing-up method, by integrating the levels of high frequency band signals supplied from the imaging device at field or frame intervals using a high pass filter (HPF) or a band pass filter (BPF), a focus evaluation value is obtained. By moving the focus lens from the near limit position to the far limit position, the position at which the focus evaluation value becomes the maximum is obtained. By moving the focus lens to the position, the auto focus function is accomplished.

[Patent Document 1] Japanese Patent Publication No. 2966458

### SUMMARY OF THE INVENTION

An output signal of an imaging device of an imaging apparatus is generated in such a manner that a two-dimensional area that has two directions of vertical and horizontal directions is scanned in the horizontal (lateral) direction and then scanned in the vertical (longitudinal) direction. In other words, high and low frequency components of an output signal represent fineness and roughness of gradation in the horizontal direction, which is the first scanning direction of the two-dimensional area.

Thus, the focus position of an object, for example a vertical line, which has gradation in the horizontal direction, can be easily detected. In contrast, when an object does not have gradation in the horizontal direction, but the vertical direction, for example, a horizontal line, since the frequency components of the output signal become flat, the differences of focus evaluation values are not obtained. Thus, it is difficult to obtain the focus position of such an object.

To solve this issue, an object of for example lateral stripes may be scanned in the vertical direction by a filter to which appropriate numbers of taps are designated in the line direction with delay devices. However, since the circuit scale of the filter that processes adjacent lines become large and the power consumptions increase. In addition, since the characteristics of the horizontal and vertical filters are different, the focus evaluation values obtained from these filters are incapable of being compared.

In view of the foregoing, it would be desirable to provide an imaging apparatus, an auto focus device, and an auto focus method that allow the focus point of an object that does not have gradation in the horizontal direction to be detected.

According to an embodiment of the present invention, there is provided an imaging apparatus having an auto focus device that controls the position of a focus lens on the basis of an evaluation value that is a signal obtained by passing predetermined band frequency contained in a video signal, the imaging apparatus including a block that converts information of an object as light that has been entered through a focus lens into a video signal, obtains a first video signal, rotates the first video signal by a predetermined angle, and obtains a second video signal; and a block that detects predetermined band frequencies of the first and second video signals and obtains their evaluation values.

According to an embodiment of the present invention, there is provided an auto focus device that controls the position of a focus lens on the basis of an evaluation value that is a signal obtained by passing predetermined band frequency contained in a video signal, the auto focus device including a block that converts information of an object as light that has been entered through a focus lens into a video signal, obtains a first video signal, rotates the first video signal by a predetermined angle, and obtains a second video signal; and a block that detects predetermined band frequencies of the first and second video signals and obtains their evaluation values.

According to an embodiment of the present invention, there is provided an auto focus method that controls the position of a focus lens on the basis of an evaluation value that is a signal obtained by passing predetermined band frequency contained in a video signal, the auto focus method including the steps of converting information of an object as light that has been entered through a focus lens into a video signal, obtaining a first video signal, rotating the first video signal by a predetermined angle, and obtaining a second video signal; and detecting predetermined band frequencies of the first and second video signals and obtaining their evaluation values.

According to an embodiment of the present invention, even if an object does not have gradation in the horizontal direction, when it has gradation in the vertical direction, it can be focused.

According to an embodiment of the present invention, a mathematical function that obtains focus evaluation values with an output signal of an imaging device can be accomplished by a mathematical function that is equivalent in the horizontal direction case. Since vertical and horizontal focus evaluation values are handled with similar mathematical functions, when the positions of the focus lens for the maximum horizontal and vertical focus evaluation values are different, their values can be compared and the larger value can be determined as the focus position.

According to an embodiment of the present invention, when an auto focus detection area is limited to a part of the entire screen, the circuit scale and power consumption can be decreased.

These and other objects, features and advantages of the present invention will become more apparent in light of the following detailed description of a best mode embodiment thereof, as illustrated in the accompanying drawings.

### BRIEF DESCRIPTION OF THE DRAWINGS

The invention will become more fully understood from the following detailed description, taken in conjunction with the accompanying drawing, wherein similar reference numerals denote similar elements, in which:

FIG. 1 is a block diagram showing a digital video camera according to an embodiment of the present invention.

FIG. 2 is a graph showing the relationship between focus evaluation values and positions of a focus lens.

FIG. 3A and FIG. 3B are schematic diagrams showing a scanning direction of a video signal and a read direction of a memory control portion according to an embodiment of the present invention.

FIG. 4A, FIG. 4B, and FIG. 4C are schematic diagrams showing the relationships between write times and read times for memories of a detector block according to an embodiment of the present invention.

FIG. 5 is a block diagram showing another example of the digital video camera according to an embodiment of the present invention.

FIG. 6 is a schematic diagram showing an example of a screen in which an auto focus detection effective area is set.

### DETAILED DESCRIPTION OF THE PREFERRED EMBODIMENTS

Next, with reference to the accompanying drawings, an embodiment of the present invention will be described. According to the present invention, the imaging apparatus is described as a digital video camera. Of course, the imaging apparatus may be other than a digital video camera. In other words, the imaging apparatus may be for example a digital still camera or a camcorder (a coined word of camera and recorder).

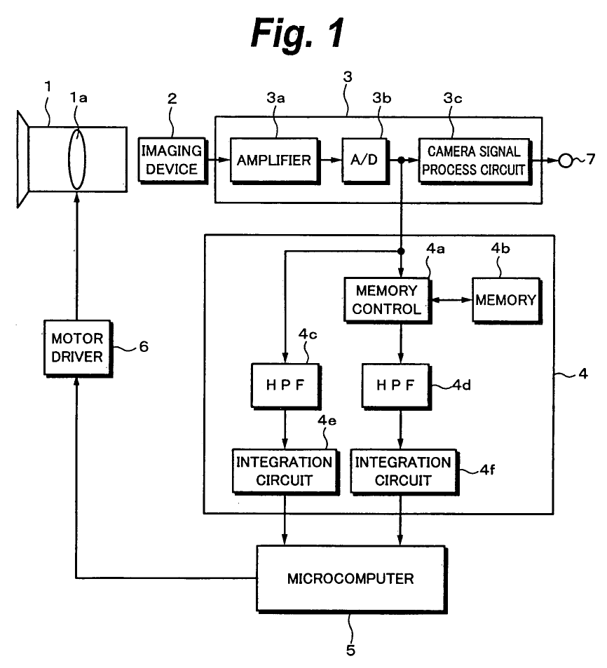

FIG. 1 is a block diagram showing the structure of a signal process system of a digital video camera according to an embodiment of the present invention. FIG. 1, a block diagram, shows in detail the structures of features of an embodiment of the present invention. The structure of the other portions will be briefly described when necessary. In FIG. 1, reference numeral 1 represents a lens device that includes a focus lens 1a. The lens device 1 also includes a zoom lens and a compensation lens (not shown). Light of an object enters an imaging device 2 through the lens device 1. The imaging device 2 converts the light into an electric signal. The imaging device 2 is for example a charge coupled device (CCD) or a complementary metal oxide semiconductor (CMOS) imager.

Reference numeral 3 represents a signal process block that converts an output signal of the imaging device 2 into a proper video signal. The signal process block 3 is composed of for example an amplifier 3a, an A/D converter 3b, and a camera signal process circuit 3c.

An analog output signal that is output from the imaging device 2 is supplied to the amplifier 3a. The amplifier 3a amplitudes the analog signal for a predetermined signal amount. The amplifier 3a outputs the amplified video signal to the A/D converter 3b. The A/D converter 3b converts the video signal into a digital video signal. The A/D converter 3b supplies the digital video signal to the camera signal process circuit 3c.

The camera signal process circuit 3c performs various signal processes for the supplied signal. For example, when the supplied signal is a signal composed of primary color signal components (GRB) and an output signal of a video output portion 7 is a signal composed of a luminance signal component and color difference signal components, processing of converting the signal is executed. A signal supplied to the camera signal process circuit 3c depends on the types of the filters used in the imaging device 2, for example a primary color filter or a complementary color filter, the structure of the 3CCD, or the like.

The camera signal process circuit 3c performs an automatic gain control (AGC) process, a contour compensation (aperture compensation) process, a color reproduction compensation process, a gamma (γ) compensation process, and so forth. The gamma compensation process allows the camera side to compensate nonlinearity between an input voltage and an exposure amount of an output device such as a cathode ray tube (CRT), a personal computer, or the like. In addition, the camera signal process circuit 3c performs an auto exposure (AE) process that controls the exposure amount of the imaging device 2 for an optimum condition. It should be noted that the foregoing processes are just examples that the camera signal process circuit 3c performs. Thus, the processes that the amplifier 3a performs are not limited to the foregoing processes.

Reference numeral 4 represents a detection block that generates a focus evaluation value with a video signal. The video signal that is output from the A/D converter 3b is supplied to a memory control portion 4a. The memory control portion 4a writes the supplied video signal to a memory 4b. In addition, the memory control portion 4a reads a video signal (a second video signal) which is obtained by rotating 90 degrees a video signal which is recorded in the memory 4b. A high pass filter (HPF) 4d detects a high frequency component for each pixel of the 90-degree rotated video signal read from the memory portion 4b. The HPF 4d supplies the detected high frequency components to an integration circuit 4f. The integration circuit 4f cumulates the high frequency component for these pixels and calculates a focus evaluation value. The calculated focus evaluation value is supplied to a microcomputer 5.

The video signal (first video signal) that is output from the A/D converter 3b is also supplied to a high pass filter (HPF) 4c. High frequency components are detected from the video signal supplied to the HPF 4c. The detected high frequency components are supplied to an integration circuit 4e. The integration circuit 4e integrates the high frequency components and calculates a focus evaluation value. The obtained focus evaluation value is supplied to the microcomputer 5. The focus evaluation value that is output from the integration circuit 4e is a value that is obtained by evaluating the video signal in the horizontal direction. The focus evaluation value that is output from the integration circuit 4f is a value that is obtained by evaluating the video signal in the vertical direction.

When the video signal is rotated 90 degrees with the memory 4b, the HPF 4c and the HPF 4d can be composed of filters in the horizontal direction case. Thus, the focus evaluation values calculated on the basis of the outputs of the filters can be compared.

The microcomputer 5 compares the absolute values of the focus evaluation values supplied from the integration circuit 4e and the integration circuit 4f and determines the larger absolute value as the focus position. The microcomputer 5 supplies a command signal corresponding to the determined focus position to a motor driver 6. The motor driver 6 drives and controls the position of the focus lens corresponding to the command signal supplied from the microcomputer 5.

The motor driver 6 is a stepping motor, a linear motor, or the like. The microcomputer 5 fixes the position of the focus lens at frame intervals of the video signal and moves the position of the focus lens from the near limit position to the far limit position at frame intervals and obtains at each lens position the relationship between the object and the focus evaluation value.

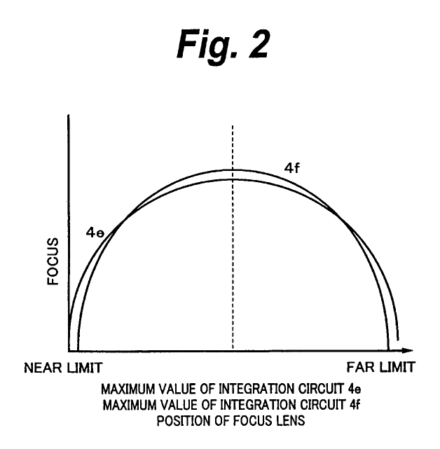

FIG. 2 shows the relationship between the focus evaluation values and the positions of the focus lens. In the example shown in FIG. 2, the maximum value of the focus evaluation values that are output from the integration circuit 4e matches the maximum value of the focus evaluation values that are output from the integration circuit 4f. The microcomputer 5 moves the focus lens to the position where the focus evaluation value is the maximum, to focus the object. When the maximum values of the horizontal and vertical focus evaluation values do not match, the larger absolute value is prioritized against the other. In other words, a crest that has a larger absolute value than the other is detected and the position of the focus lens is controlled on the basis of the detected crest.

Thus, when there is a video signal of an object that does not have gradation in the horizontal direction, since the output of the integration circuit 4e does not almost contain a crest, the position of the focus lens can be determined with the crest of the output of the integration circuit 4f.

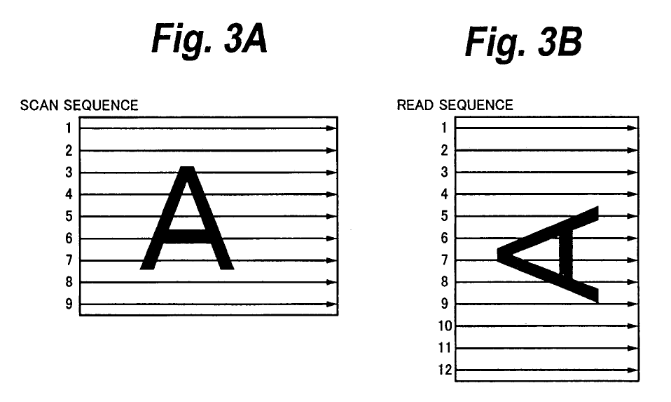

FIG. 3A shows the scanning direction of the output signal from the imaging device 2 and the input signal of the detection block 4. A video signal of an object containing latter “A” is normally scanned in the horizontal direction. When the memory control portion 4a reads a video signal that contains for example letter “A” from the memory 4b, the video signal is rotated 90 degrees as shown in FIG. 3B. The video signal can be rotated in any direction, clockwise or counterclockwise.

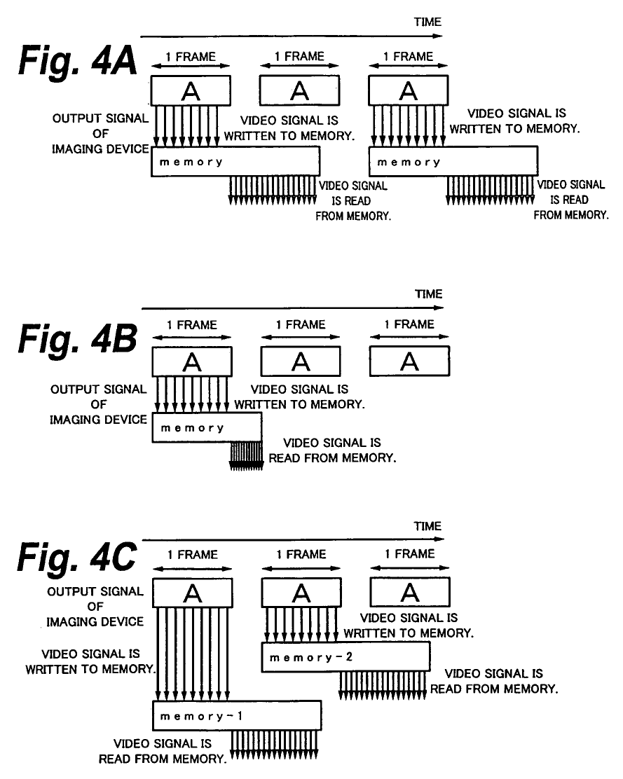

FIG. 4A, FIG. 4B, and FIG. 4C show the relationships between times of reading and writing for the memory 4b of the detection block 4 an output signal of the imaging device 2 and an input signal of the detection block 4. While a video signal is written to the memory 4b, a video signal is not read from the memory 4b. Thus, after an output signal for one frame has been written from the imaging device to the memory 4b, it is necessary to read the video signal therefrom.

In the method shown in FIG. 4A, the write process and the read process for the memory 4b are alternately performed at frame intervals. In the method shown in FIG. 4B, a video signal for one frame is written to the memory 4b. The video signal for this frame is read from the memory 4b before a video signal of the next frame is written thereto (in a vertical blanking period). The method shown in FIG. 4B needs a higher speed memory than that used in the method shown in FIG. 4A. However, in the method shown in FIG. 4B, the memory does not need to increase the capacity and can use all frames of the video signal.

The method shown in FIG. 4C is referred to as the two-bank system or the like. In this method, with memories 1 and 2 each of which has a storage capacity for two frames, the write and read processes are alternately performed. In the method shown in FIG. 4A, a horizontal focus evaluation value that is output from the integration circuit 4e deviates by one frame from a vertical focus evaluation value that is output from the integration circuit 4f and only half of all frames are detected. However, in these methods, the focus position can be more easily and accurately detected than is the case that vertical focus evaluation values are not detected. It should be noted that these method are just examples. Alternatively, the write and read processes for a video signal may be preformed by another method. In addition, according to the foregoing embodiment, a non-interlaced scanned video signal is used. When an interlaced scanned video signal is used, the video signal is processed at field intervals.

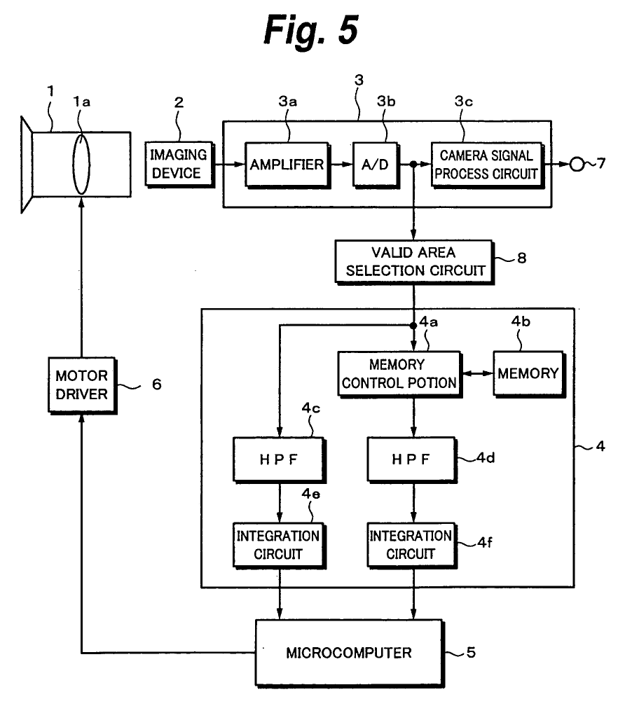

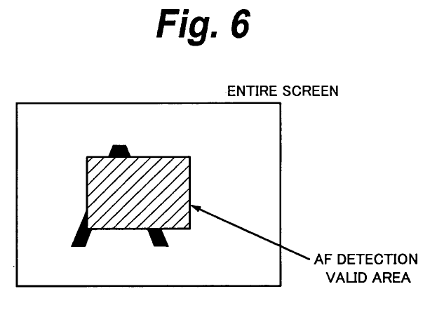

Next, with reference to FIG. 5, another embodiment of the present invention will be described. In the structure shown in FIG. 5, a valid area selection circuit 8 is disposed between the connection point of the A/D converter 3b and the camera signal process circuit 3c and the detection block 4. When an object is automatically focused by a digital camera or the like, for example only a partial area of the screen is validated as a detection signal as shown in FIG. 6 to improve the focus performance of the auto focus operation. The valid area selection circuit 8 determines an area to be validated as a detection signal. When the valid area selection circuit 8 is disposed and a part of the screen is designated as a detection signal for the auto focus operation, the circuit scale and the power consumption can be decreased.

It should be understood by those skilled in the art that various modifications, combinations, sub-combinations and alternations may occur depending on design requirements and other factors insofar as they are within the scope of the appended claims or the equivalents thereof. For example, the HPF 4c and the HPF 4d may be composed of a band pass filter (BPF) or a differentiation circuit.

Alternatively, when a plurality of distance measurement frames are displayed on a liquid crystal panel of a digital camera or the like and the focus evaluation values of these distance measurement frames are desired, the HPFs may be disposed in parallel to obtain the focus evaluation values thereof.

1. An imaging apparatus having an auto focus device that controls the position of a focus lens on the basis of an evaluation value that is a signal obtained by passing predetermined band frequency contained in a video signal, the imaging apparatus comprising:
means for converting information of an object as light that has been entered through a focus lens into a video signal, obtaining a first video signal, rotating the first video signal by a predetermined angle, and obtaining a second video signal; and
means for detecting predetermined band frequencies of the first and second video signals and obtaining their evaluation values.

2. The imaging apparatus as set forth in claim 1, further comprising:
means for comparing the absolute values of the evaluation values, controlling the position of the focus lens on the basis of the evaluation value whose absolute value is larger than the other, and determining the focus position of the focus lens.

3. The imaging apparatus as set forth in claim 1,
wherein the second video signal is a video signal that is obtained by rotating 90 degrees the first video signal.

4. The imaging apparatus as set forth in claim 2,
wherein the second video signal is a video signal that is obtained by rotating 90 degrees the first video signal.

5. The imaging apparatus as set forth in claim 1, further comprising:
means for validating a predetermined area of the first video signal.

6. The imaging apparatus as set forth in claim 1, further comprising:
filters that detect the predetermined band frequencies of the first and second video signal, the characteristics of the filters being the same.

7. An auto focus device that controls the position of a focus lens on the basis of an evaluation value that is a signal obtained by passing predetermined band frequency contained in a video signal, the auto focus device comprising:
means for converting information of an object as light that has been entered through a focus lens into a video signal, obtaining a first video signal, rotating the first video signal by a predetermined angle, and obtaining a second video signal; and
means for detecting predetermined band frequencies of the first and second video signals and obtaining their evaluation values.

8. The auto focus device as set forth in claim 7, further comprising:
means for comparing the absolute values of the evaluation values, controlling the position of the focus lens on the basis of the evaluation value whose absolute value is larger than the other, and determining the focus position of the focus lens.

9. The auto focus device as set forth in claim 7,
wherein the second video signal is a video signal that is obtained by rotating 90 degrees the first video signal.

10. The auto focus device as set forth in claim 8,
wherein the second video signal is a video signal that is obtained by rotating 90 degrees the first video signal.

11. The auto focus device as set forth in claim 7, further comprising:
means for validating a predetermined area of the first video signal.

12. The auto focus device as set forth in claim 7, further comprising:
filters that detect the predetermined band frequencies of the first and second video signal, the characteristics of the filters being the same.

13. An auto focus method that controls the position of a focus lens on the basis of an evaluation value that is a signal obtained by passing predetermined band frequency contained in a video signal, the auto focus method comprising the steps of:
converting information of an object as light that has been entered through a focus lens into a video signal, obtaining a first video signal, rotating the first video signal by a predetermined angle, and obtaining a second video signal; and
detecting predetermined band frequencies of the first and second video signals and obtaining their evaluation values.

14. The auto focus method as set forth in claim 13, further comprising the step of:
comparing the absolute values of the evaluation values, controlling the position of the focus lens on the basis of the evaluation value whose absolute value is larger than the other, and determining the focus position of the focus lens.

15. The auto focus method as set forth in claim 13,
wherein the second video signal is a video signal that is obtained by rotating 90 degrees the first video signal.

16. The auto focus method as set forth in claim 14,
wherein the second video signal is a video signal that is obtained by rotating 90 degrees the first video signal.

17. The auto focus method as set forth in claim 13, further comprising the step of:
validating a predetermined area of the first video signal.

18. The auto focus method as set forth in claim 13,
wherein the predetermined band frequencies of the first and second video signal are detected by filters, the characteristics of the filters being the same.

19. An imaging apparatus having an auto focus device that controls the position of a focus lens on the basis of an evaluation value that is a signal obtained by passing predetermined band frequency contained in a video signal, the imaging apparatus comprising:
a portion converting information of an object as light that has been entered through a focus lens into a video signal, obtaining a first video signal, rotating the first video signal by a predetermined angle, and obtaining a second video signal; and
a portion detecting predetermined band frequencies of the first and second video signals and obtaining their evaluation values.

20. An auto focus device that controls the position of a focus lens on the basis of an evaluation value that is a signal obtained by passing predetermined band frequency contained in a video signal, the auto focus device comprising:
a portion converting information of an object as light that has been entered through a focus lens into a video signal, obtaining a first video signal, rotating the first video signal by a predetermined angle, and obtaining a second video signal; and
a portion detecting predetermined band frequencies of the first and second video signals and obtaining their evaluation values.
